(19) United States
(12) Patent Application Publication
(10) Pub. No.: US 2026/0032460 A1
(43) Pub. Date: Jan. 29, 2026

(54) Methods For Reporting Predicted RSRPs in Spatial Domain

(71) Applicant: InterDigital Patent Holdings, Inc., Wilmington, DE (US)

(72) Inventors: Haseeb Ur Rehman, Winnipeg (CA); Young Woo Kwak, Woodbury, NY (US); Nazli Khan Beigi, Longueuil (CA); Prasanna Herath, Laval (CA); Shahab Hamidi-Rad, Sunnyvale, CA (US); Moon IL Lee, Melville, NY (US); Yugeswar Deenoo Narayanan Thangaraj, Chalfont, PA (US)

(73) Assignee: InterDigital Patent Holdings, Inc., Wilmington, DE (US)

(21) Appl. No.: 18/786,185

(22) Filed: Jul. 26, 2024

(51) Int. Cl. H04W 16/28; H04B 7/06; H04B 17/309; H04B 17/318

(52) U.S. Cl. CPC H04W 16/28; H04B 7/0632; H04B 17/328; H04B 17/346

(57) ABSTRACT

A wireless transceiver/receiver unit (WTRU) comprises a processor configured to receive configuration information that may include an indication of a first and second set of beams, where the second set of beams may be a subset of the first set of beams. The configuration may include an indication of a first set of reference signals (RSs) resources associated with the first set of beams and an indication of a second set of RS resources associated with the second set of beams. The processor may determine a measured beam quality associated with each of the beams of the second set of beams based on measurements performed on the second set of RS resources, determine a predicted measurement associated with each of the beams of the first set of beams based on the measured beam quality for the one or more beams of the second set of beams, and send a report.

### BACKGROUND

In traditional beam management procedure, all the beams in a cell were transmitted and measured to identify a best beam and receive channels and signals. However, in Artificial Intelligence/Machine Language (AI/ML) based downlink (DL) transmission (Tx) beam prediction, reference signals (RSs) for only selected beams may be transmitted and AI/ML model estimates qualities of other beams based on measurements of the selected beams. This technology could be the great foundation in improving performance and complexity in conventional beam management aspects, including beam prediction in time, and/or spatial domain for overhead and latency reduction, beam selection accuracy improvement, and possible other aspects.

### SUMMARY

A wireless transceiver/receiver unit (WTRU) may comprise a processor. The processor may be configured to receive configuration information. The configuration information may include, for example, an indication of a first set of beams and an indication of a second set of beams. The second set of beams may be a subset of the first set of beams. The configuration may include an indication of a first set of reference signals (RSs) resources associated with the first set of beams and an indication of a second set of RS resources associated with the second set of beams. The processor may be configured to determine a measured beam quality associated with at least one of the beams of the second set of beams based on measurements performed on the second set of RS resources. The processor may be configured to determine a predicted measurement associated with at least one of the beams of the first set of beams based on the measured beam quality for the one or more beams of the second set of beams. The processor may be configured to send a report. The report may include, for example, an indication of a first subset of beams of the first set of beams and an indication of a second subset of beams of the second set of beams where the first subset of beams is not part of the second set of beams. The first subset of beams may be determined differently than the second subset of beams. In some examples, different criteria used to determine whether the report comprises a measured beam quality or a predicted beam quality for each beam of the first subset of beams than is used to determine whether the report comprises a measured beam quality or a predicted beam quality for each beam of the second subset of beams. For example, the WTRU may be configured to determine whether the report comprises a measured beam quality or a predicted beam quality for each beam of the first subset of beams using first criteria, and the processor may be configured to determine whether the report comprises a measured beam quality or a predicted beam quality for each beam of the second subset of beams using second criteria that is different than the first criteria. As such, whether the report comprises a measured beam quality or a predicted beam quality for each beam of the first subset of beams may be determined by the WTRU independent of (e.g., using different criteria) whether the report comprises a measured beam quality or a predicted beam quality for each beam of the second subset of beams.

The measured beam quality may be, for example, Reference Signal Received Power (RSRP), Signal-to-Interference-plus-Noise Ratio (SINR), or noise power.

The second subset of beams may be determined, for example, from the second set of beams based on a measured or predicted Reference Signal Received Power (RSRP) associated with each beam of the second set of beams.

The report may include, for example, a measured or predicted beam quality for each beam or at least one beam of the second subset of beams.

For each beam of the second subset, the report may include, for example, a predicted beam quality for the beam when one or more conditions associated with the beam are satisfied, and otherwise, the report comprises a measured beam quality for the beam.

In some examples, the one or more conditions may be any combination of: (i) a Signal-to-Interference-plus-Noise Ratio (SINR) associated with the beam being less than a SINR threshold, (ii) a CQI associated with the beam being less than a CQI threshold, (iii) a noise power associated with the beam being greater than a noise power threshold and an SINR associated with the beam being greater than a SINR threshold, (iv) a speed of the WTRU speed being less than a speed threshold, and/or a Line of Sight (LOS) probability associated with the beam being less than a LOS threshold.

In some examples, the report may include a predicted beam quality for each beam of the first subset of beams.

A WTRU may be configured to perform a method that includes one or more of the following steps. The method may include receiving configuration information. The configuration information may include, for example, an indication of a first set of beams and an indication of a second set of beams. The second set of beams may be a subset of the first set of beams. The configuration may include an indication of a first set of reference signals (RSs) resources associated with the first set of beams and an indication of a second set of RS resources associated with the second set of beams. The method may include determining a measured beam quality associated with each of the beams of the second set of beams based on measurements performed on the second set of RS resources. The method may be include determining a predicted measurement associated with each of the beams of the first set of beams based on the measured beam quality for the one or more beams of the second set of beams. The include sending a report. The report may include, for example, an indication of a first subset of beams of the first set of beams and an indication of a second subset of beams of the second set of beams where the first subset of beams is not part of the second set of beams; The first subset of beams may be determined differently than the second subset of beams. In some examples, different criteria used to determine whether the report comprises a measured beam quality or a predicted beam quality for each beam of the first subset of beams than is used to determine whether the report comprises a measured beam quality or a predicted beam quality for each beam of the second subset of beams. For example, the WTRU may be configured to determine whether the report comprises a measured beam quality or a predicted beam quality for each beam of the first subset of beams using first criteria, and the WTRU may be configured to determine whether the report comprises a measured beam quality or a predicted beam quality for each beam of the second subset of beams using second criteria that is different than the first criteria. As such, whether the report comprises a measured beam quality or a predicted beam quality for each beam of the first subset of beams may be determined by the WTRU independent of (e.g., using different criteria) whether the report comprises a measured beam quality or a predicted beam quality for each beam of the second subset of beams.

The measured beam quality may be, for example, Reference Signal Received Power (RSRP), Signal-to-Interference-plus-Noise Ratio (SINR), or noise power.

The second subset of beams may be determined, for example, from the second set of beams based on a measured or predicted Reference Signal Received Power (RSRP) associated with each beam of the second set of beams.

The report may include, for example, a measured or predicted beam quality for each beam or at least one beam of the second subset of beams.

For each beam of the second subset, the report may include, for example, a a predicted beam quality for the beam when one or more conditions associated with the beam are satisfied, and otherwise, the report comprises a measured beam quality for the beam.

In some examples, the one or more conditions may be any combination of: (i) a Signal-to-Interference-plus-Noise Ratio (SINR) associated with the beam being less than a SINR threshold, (ii) a CQI associated with the beam being less than a CQI threshold, (iii) a noise power associated with the beam being greater than a noise power threshold and an SINR associated with the beam being greater than a SINR threshold, (iv) a speed of the WTRU speed being less than a speed threshold, and/or a Line of Sight (LOS) probability associated with the beam being less than a LOS threshold.

In some examples, the report may include a predicted beam quality for each beam of the first subset of beams.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

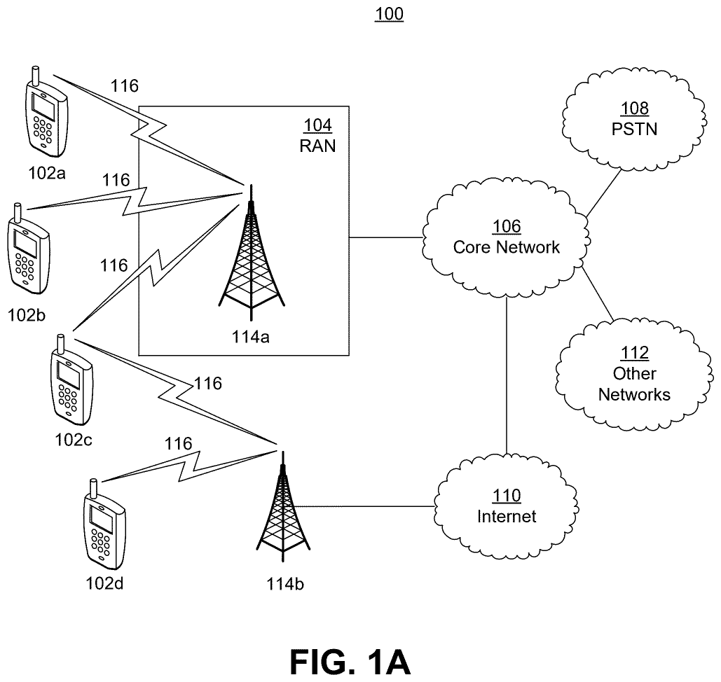

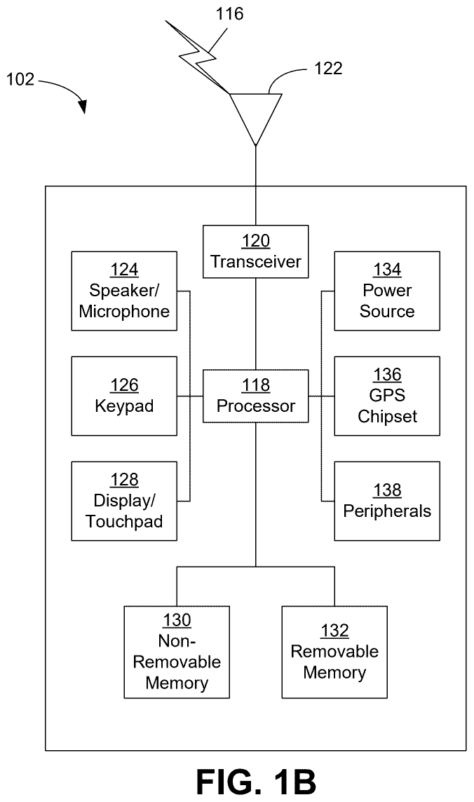

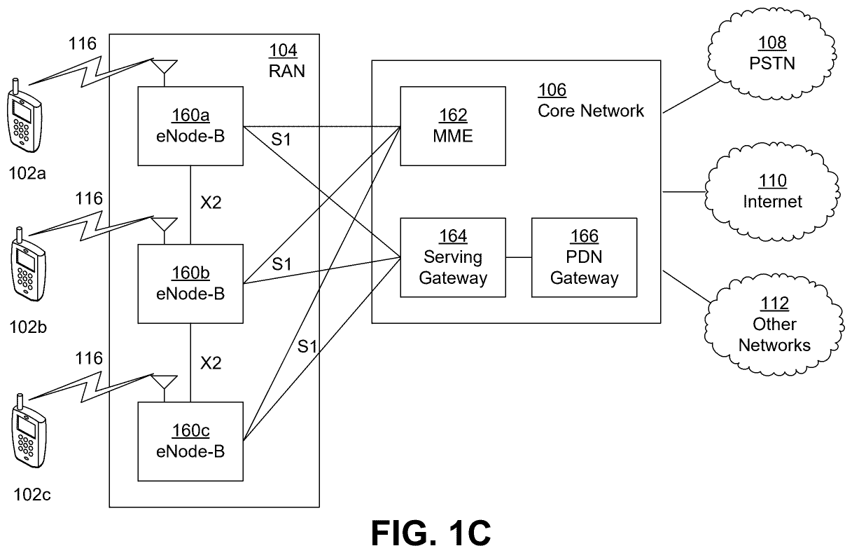

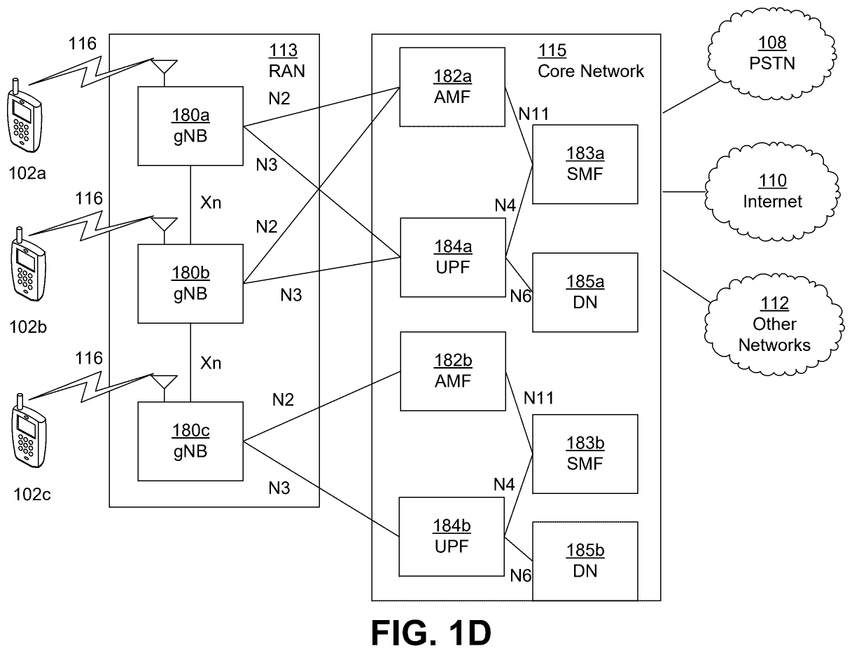

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Objectives for beam management (BM) may include Downlink (DL) Transmission (Tx) beam prediction for both WTRU-sided model and network (NW)-sided model, encompassing [RAN1/RAN2]: Spatial-domain DL Tx beam prediction for Set A of beams based on measurement results of Set B of beams (“BM-Case1”); Temporal DL Tx beam prediction for Set A of beams based on the historic measurement results of Set B of beams (“BM-Case2”); Specify necessary signaling/mechanism(s) to facilitate LCM operations specific to the Beam Management use cases, if any; and Enabling method(s) to ensure consistency between training and inference regarding NW-side additional conditions (if identified) for inference at WTRU. Note: Strive for common framework design to support both BM (beam management)-Case1 and BM-Case2.

Dynamic reporting of measured and predicted RSRPs for beams/RSs associated to measurement set (e.g., Set B) and prediction Set (e.g., Set A). Method for reporting RSRPs beams associated to Set B may include Dynamic reporting of either measured or predicted RSRP associated to Set B beams based on measurement value, measurement accuracy and prediction accuracy. Method for reporting RSRPs beams associated to Set A may include Dynamic reporting of either measured or predicted RSRP associated to Set A beams based on prediction time, reporting time, measurement value and measurement accuracy.

The use case for Artificial Intelligence/Machine Learning (AI/ML) with respect to beam management may be to predict one or more best beams of among a set of beams with more accuracy and less overhead than legacy beam management procedures. Another use case for AI/ML with respect to beam management may be to predict qualities of beams including unmeasured beams based on the measured qualities of beams. In current specification for beam management, the reference signals (RSs) signals associated with a beam are measured by the WTRU to determine the beam quality and a best beam(s) are reported among the measured beams. In contrast, an AI/ML model in a WTRU (or gNB) may predict one or more beams out of all possible beams including those not measured by the WTRU (e.g., or next generation Node B (gNB)). An AI/ML model may also predict beam qualities of unmeasured beams. The input to the AI/ML may be a set of beam measurements associated to a set of reference signals. The input set may be denoted by Set B. The AI/ML model may predict a best beam (e.g., a beam index) and/or qualities of beams from an output predicted set of beams, that may be denoted by Set A. Here, Set B is a subset of Set A.

After the WTRU makes a prediction for best beams, the WTRU may report predicted beams to the network. The WTRU may also report predicted and/or measured qualities of reported beams to the gNB to assist gNB's beam scheduling. For one or more reported beams, the WTRU may have both predicted and measured associated beam quality. In some scenarios, a predicted quality of a beam may be closer to ground truth (e.g. true quality of a beam) than a measured quality, while in other scenarios (low signal-to-noise ratio (SNR) channel), the opposite may be true (e.g., measured beam quality is accurate than predicted beam quality). The WTRU may report one type of beam qualities depending upon the current scenario. Therefore, a procedure to report predicted beam qualities may be beneficial.

The WTRU may report measured beam qualities of the indicated beams. However, when the WTRU reports predicted beams to the NW, the WTRU may not have measured beam qualities available for a set of reported beams. For another set of beams, the WTRU may have both measured and predicted beam qualities to report, and the WTRU may have to include only type of the beam qualities in the WTRU report. Therefore, a procedure to report predicted beam qualities optimally may be needed.

The WTRU may receive a configuration RSs associated to measurement set, prediction set and WTRU report. Based on RS measurements, the WTRU may predict beams and predicted reference signal received power (RSRPs). The WTRU may report predicted beams to a gNB. Based on RS measurements (e.g., noise power, signal-to-interference plus noise ratio (SINR)) prediction quality metrics, and report configuration, the WTRU my report either measured or RSRPs associated to the reported beams.

The WTRU may be configured to receive configuration information. The configuration information may include, for example, an indication of a first set of beams and an indication of a second set of beams. The second set of beams may be a subset of the first set of beams. The configuration may include an indication of a first set of reference signals (RSs) resources associated with the first set of beams and an indication of a second set of RS resources associated with the second set of beams. For example, the WTRU may receive a configuration of: (i) one RS resource set containing RS resource configurations for both Set A and Set B; an indication of Set A/Set B resource through RS resource config.; (ii) two or more RS resource sets associated with Set A and Set B(s); (iii) one or more channel state information-interference measurement (CSI-IM) resources (e.g., corresponding to beams in Set B and/or Set A); and/or thresholds (e.g., thresholds for measurement/prediction accuracy, time difference).

The WTRU may perform beam measurements on RSs associated to Set B and/or Set A. The WTRU may perform measurements on CSI-IM resources (e.g., to determine interference power associated to one or more beams).

The WTRU may determine the measured beam qualities (e.g., RSRP, SINR, noise power) based RS measurements of RS resources associated to Set B. The WTRU may predict beam measurements for RS resources associated to Set A, based on RS measurements associated to Set B. The WTRU may determine the Top-K beams (e.g., the K beams with highest measured or predicted beam quality). The Top-K beams may be an integer number of beams.

The WTRU may determine to report measured or predicted beam qualities (e.g., RSRPs) of the Top-K beams. In some examples, the WTRU may use different criteria to determine whether the report comprises a measured beam quality or a predicted beam quality for the beams of a first subset of beams (e.g., Set A) than the WTRU uses to determine whether the report comprises a measured beam quality or a predicted beam quality for the beams of a second subset of beams (e.g., Set B). For instance, the WTRU may use different Modes, such as those defined herein, for reporting the beams of Set A (e.g., the Top-K beams of Set A) than the mode used to report the beams of Set B (e.g., the Top-K beams of Set B). For example, the WTRU may be configured to determine whether the report comprises a measured beam quality or a predicted beam quality for the beams of a first subset of beams of Set A using first criteria, and the WTRU may be configured to determine whether the report comprises a measured beam quality or a predicted beam quality for the beams of a second subset of beams Set B using second criteria that is different than the first criteria.

The WTRU may report a measured beam quality (e.g., RSRP) of a Top-K beams associated to Set B. For instance, the WTRU may be configured or may select (e.g., based on beam prediction accuracy, average SINR, and/or noise power) to report via one or more of the following reporting modes. According to a first mode (e.g., Mode 1), the WTRU may report measured RSRPs of Top-K beams associated to Set B. According to a second mode (e.g., Mode 2), the WTRU may report predicted RSRPs of Top-K beams associated to Set B.

According to a third mode (e.g., Mode 3), the WTRU may select a per beam mode for reporting. For example, the WTRU may report differently for each beam when configured with the third mode. For example, the WTRU may report predicted RSRPs for one or more reported (e.g., Top-K) Set B beam(s) based on one or more of the following conditions being satisfied by that beam (e.g., and otherwise, the WTRU may select Mode 1). The conditions may include any combination of (a) SINR/CQI being less than a first measurement threshold; (b) Noise power being greater than a second measurement threshold and SNR/SINR being greater than a third measurement threshold; (c) WTRU speed being less than a fourth measurement threshold; (d) LOS probability being less than a fifth measurement threshold (e) a difference between L1-RSRP and L3-RSRP being greater than a sixth measurement threshold; and/or (f) measured RSRP falling outside a NW-configured confidence interval for measured RSRP (e.g., determined based on a prediction accuracy threshold).

The WTRU may report a measured beam quality (e.g., RSRP) of a Top-K beams associated to Set A (e.g., but that are not in Set B). For example, the WTRU may be configured to report via one of more of the following modes. According to a first mode (e.g., Mode 1), the WTRU may report predicted RSRPs (e.g., absolute and/or differential) of all Top-K beams associated to Set A. According to a second mode (e.g., Mode 2), the WTRU may report predicted RSRPs of the best and worst of Top-K beams. According to a third mode (e.g., Mode 3), the WTRU may report measured RSRPs for Top-K beams associated to Set A for which the difference between the beam's RSRP measurement time and the report time is less than a first time difference threshold.

In some examples, the WTRU may report on the Top-K beams (e.g., that are associated to Set A) for which a time difference between the RSRP measurement and a reporting time is greater than the first time difference threshold but less than a second time difference threshold. In such examples, the WTRU may report the predicted RSRP based on one or more of the following conditions being satisfied by the beam (e.g., and otherwise the WTRU may report measured RSRP). The conditions may include any combination of the following: (i) a noise power associated with a beam being greater than a a seventh measurement threshold; (ii) an SINR/CQI being less than an eighth measurement threshold; (iii) a noise power associated to a beam being greater than a ninth measurement threshold and the SNR/SINR being greater than a tenth measurement threshold; (iv) a speed of the WTRU being less than an eleventh measurement threshold; and/or (v) a Line of Sight (LOS) probability being less than a twelfth measurement threshold. In some examples, the WTRU may report predicted RSRPs for the other Top-K beams (e.g., beams associated to Set A (and not Set B) for which the time difference between the RSRP measurement and the reporting time greater than second time difference threshold).

The WTRU may send an indication indicating the predicted RSRPs and/or measured RSRPs (e.g., per beam indication via a bitmap). In some examples, the WTRU may send an indication indicating whether absolute RSRP(s) (e.g., of the Top-1 beam) is included in the report (e.g., via a 1-bit indication).

The examples described herein may enable the WTRU to dynamically report predicted and/or measured RSRPs of beams to a gNB, which for example, may reduce reporting overhead for the WTRU and/or may improve the gNB's decision making by improving the accuracy of the reported RSRPs. Even though the examples above describe beam quality in reference to RSRP, other beam quality metrics may be used (e.g. SINR, noise power, etc.).

Artificial intelligence (AI) may be defined as the behavior exhibited by machines. Such behavior may, for example, mimic cognitive functions to sense, reason, adapt and/or act.

Machine learning (ML) may refer to types of algorithms that solve a problem based on learning through experience (e.g., ‘data’), without explicitly being programmed (e.g., ‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some examples, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning (DL) refers to class of machine learning algorithms that employ artificial neural networks (specifically DNNs) which were loosely inspired from biological systems. Deep Neural Networks (DNNs) are a special class of machine learning models inspired by human brain wherein the input is linearly transformed and pass-through non-linear activation function multiple times. DNNs typically consists of multiple layers where each layer consists of linear transformation and a given non-linear activation functions. The DNNs can be trained using the training data via back-propagation algorithm. Recently, DNNs have shown state-of-the-art performance in variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

A WTRU may transmit or receive a physical channel or reference signal according to at least one spatial domain filter. The term “beam” may be used to refer to a spatial domain filter. The WTRU may transmit a physical channel or signal using the same spatial domain filter as the spatial domain filter used for receiving an RS (e.g. Channel State Information (CSI)-RS) or a Synchronization Signal (SS) block. The WTRU transmission may be referred to as “target”, and the received RS or SS block may be referred to as “reference” or “source”. In such case, the WTRU may be said to transmit the target physical channel or signal according to a spatial relation with a reference to such RS or SS block. The WTRU may transmit, for instance, a first physical channel or signal according to the same spatial domain filter as the spatial domain filter used for transmitting a second physical channel or signal. The first and second transmissions may be referred to as “target” and “reference” or “source”, respectively. In such case, the WTRU may, for example, transmit the first (target) physical channel or signal according to a spatial relation with a reference to the second (reference) physical channel or signal. A spatial relation may be implicit, configured by Radio Resource Control (RRC) or signaled by Medium Access Control-Control Element (MAC-CE) or Downlink Control Information (DCI). For example, a WTRU may implicitly transmit Physical Uplink Shared Channel (PUSCH) and Demodulation Reference Signal (DM-RS) of PUSCH according to the same spatial domain filter as an Sounding Reference Signal (SRS) indicated by an SRS Resource Indicator (SRI) indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (e.g., target) downlink channel or signal according to the same spatial domain filter or spatial reception parameter as a second (e.g., reference) downlink channel or signal. For example, such association may exist between a physical channel such as Physical Downlink Control Channel (PDCCH) or Physical Downlink Control Channel (PDSCH) and its respective DM-RS. When the first and second signals are reference signals, an association may exist when the WTRU is configured with a quasi-colocation (QCL) assumption type D between corresponding antenna ports. An association may be configured as a transmission configuration indicator (TCI) state. A WTRU may indicate an association between a CSI-RS or SS block and a DM-RS by an index to a set of TCI states configured by RRC and/or signaled by MAC CE. Such indication may also be referred to as a “beam indication”.

A TRP (e.g., transmission and reception point) may be interchangeably used with one or more of TP (transmission point), RP (reception point), RRH (radio remote head), DA (distributed antenna), BS (base station), a sector (of a BS), and/or a cell (e.g., a geographical cell area served by a BS). Multi-TRP may be interchangeably used with one or more of MTRP, M-TRP, and/or multiple TRPs.

A WTRU may report a subset of channel state information (CSI) components. The CSI components may correspond to any combination of the following. The CSI components may include CSI-RS resource indicator (CRI). The CSI components may include a SSB resource indicator (SSBRI). The CSI components may include an indication of a panel used for reception at the WTRU (e.g., such as a panel identity or group identity). The CSI components may include measurements, such as L1-RSRP and/or L1-SINR taken from SSB or CSI-RS (e.g., cri-RSRP, cri-SINR, ssb-Index-RSRP, ssb-Index-SINR). The CSI components may include other channel state information, such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may, for example, monitor, receive, or attempt to decode an SSB during initial access, initial synchronization, radio link monitoring (RLM), cell search, and/or cell switching.

A WTRU may measure and report the channel state information (CSI). The CSI for each connection mode may include or be configured with one or more of following. For example, the CSI may include or be configured with a CSI Report Configuration. The CSI Report Configuration may include one or more of the following. The CSI Report Configuration may include CSI report quantity, such as, Channel Quality Indicator (CQI), Rank Indicator (RI), Precoding Matrix Indicator (PMI), CSI-RS Resource Indicator (CRI), Layer Indicator (LI), etc. The CSI Report Configuration may include CSI report type, such as aperiodic, semi persistent, and/or periodic CSI report types. The CSI Report Configuration may include CSI report codebook configuration, such as, Type I, Type II, Type II port selection, etc. The CSI Report Configuration may include an indication of CSI report frequency.

The CSI for each connection mode may include or be configured with a CSI-RS Resource Set. The CSI-RS Resource Set may include one or more of the following CSI Resource settings: (a) NZP-CSI-RS Resource for channel measurement; (b) NZP-CSI-RS Resource for interference measurement; and/or (c) CSI-IM Resource for interference measurement. The CSI for each connection mode may include or be configured with a NZP CSI-RS Resources. The NZP CSI-RS Resources may include one or more of the following: (a) NZP CSI-RS Resource ID; (b) Periodicity and offset; (c) QCL Info and TCI-state; and/or (d) Resource mapping, such as, number of ports, density, and/or Code Division Multiplexing (CDM) type.

A WTRU may indicate, determine, and/or be configured with one or more reference signals. The WTRU may monitor, receive, and/or measure one or more parameters based on the respective reference signals. For example, one or more of the following parameters may apply, and are non-limiting examples of the parameters that may be included in reference signal(s) measurements.

For instance, one parameter may be SS-RSRP. SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

For instance, one parameter may be CSI-RSRP. CSI-RSRP may be measured based on the linear average over the power contribution of the resource elements (RE) that carry the respective CSI-RS. The CSI-RSRP measurement may be configured within measurement resources for the configured CSI-RS occasions.

For instance, one parameter may be SS-SINR. SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. For example, when SS-SINR is used for L1-SINR, the noise and interference power measurement may be accomplished based on resources configured by higher layers.

For instance, one parameter may be CSI-SINR. CSI-SINR may be measured based on the linear average over the power contribution of the resource elements (RE) that carry the respective CSI-RS divided by the linear average of the noise and interference power contribution. For example, when CSI-SINR is used for L1-SINR, the noise and interference power measurement may be accomplished based on resources configured by higher layers. Otherwise, the noise and interference power may be measured based on the resources that carry the respective CSI-RS.

For instance, one parameter may be RSSI. Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise).

For instance, one parameter may be CLI-RSSI. Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise).

For instance, one parameter may be SRS-RSRP. Sounding reference signals RSRP (SRS-RSRP) may be measured based on the linear average over the power contribution of the resource elements (RE) that carry the respective SRS.

A CSI report configuration (e.g., CSI-ReportConfigs) may be associated with a single Bandwidth Part (BWP) (e.g., indicated by BWP-Id). The CSI report may be configured with parameters such as CSI-RS resources and/or CSI-RS resource sets for channel and interference measurement. The CSI report may be configured with a parameter such as CSI-RS report configuration type including the periodic, semi-persistent, and aperiodic. The CSI report may be configured with a parameter such as CSI-RS transmission periodicity for periodic and semi-persistent CSI reports. The CSI report may be configured with a parameter such as CSI-RS transmission slot offset for periodic, semi-persistent and aperiodic CSI reports. The CSI report may be configured with a parameter such as CSI-RS transmission slot offset list for semi-persistent and aperiodic CSI reports. The CSI report may be configured with parameters such as time restrictions for channel and interference measurements. The CSI report may be configured with a parameter such as a report frequency band configuration (e.g. wideband/subband CQI, PMI, etc.). The CSI report may be configured with parameters such as thresholds and modes of calculations for the reporting quantities (e.g. CQI, RSRP, SINR, LI, and/or RI, etc.). The CSI report may be configured with a parameter such as a codebook configuration. The CSI report may be configured with a parameter such as group based beam reporting. The CSI report may be configured with a parameter such as a CQI table. The CSI report may be configured with a parameter such as a subband size. The CSI report may be configured with a parameter such as a non-PMI port indication. The CSI report may be configured with a parameter such as a Port Index.

A CSI-RS Resource Set (e.g., NZP-CSI-RS-ResourceSet) may include one or more of CSI-RS resources (e.g., NZP-CSI-RS-Resource and CSI-ResourceConfig). A WTRU may be configured with one or more of the following in a CSI-RS Resource: (i) CSI-RS periodicity and slot offset for periodic and semi-persistent CSI-RS Resources; (ii) CSI-RS resource mapping to define the number of CSI-RS ports, density, CDM-type, OFDM symbol, and subcarrier occupancy; (iii) The bandwidth part to which the configured CSI-RS is allocated; and/or (iv) The reference to the TCI-State including the QCL source RS(s) and the corresponding QCL type(s).

A WTRU may be configured with one or more RS resource sets. The RS resource set configuration may include one or more of following: (i) RS resource set ID; (ii) One or more RS resources for the RS resource set; (iii) Repetition (e.g., on or off); (iv) Aperiodic triggering offset (e.g., one of 0-6 slots); and/or (v) TRS info (e.g., true or not).

A WTRU may be configured with one or more RS resources. The RS resource configuration may include one or more of following: (i) RS resource ID; (ii) Resource mapping (e.g., REs in a PRB); (iii) Power control offset (e.g., one value of −8, . . . , 15); (iv) Power control offset with SS (e.g., −3 dB, 0 dB, 3 dB, 6 Db); (v) Scrambling ID; (vi) Periodicity and offset; and/or (vii) QCL information (e.g., based on a TCI state).

A property of a grant or assignment may consist of at least one of the following: (i) a frequency allocation; (ii) an aspect of time allocation, such as a duration; (iii) a priority; (iv) a modulation and coding scheme; (v) a transport block size; (vi) a number of spatial layers; (vii) a number of transports blocks; (viii) a TCI state, CRI or SRI; (ix) a number of repetitions; (x) whether the repetition scheme is Type A or Type B; (xi) whether the grant is a configured grant type 1, type 2 or a dynamic grant; (xii) whether the assignment is a dynamic assignment or a semi-persistent scheduling (configured) assignment; (xiii) a configured grant index or a semi-persistent assignment index; (xiv) a periodicity of a configured grant or assignment; (xv) a channel access priority class (CAPC); and/or (xvi) any parameter provided in a DCI, by MAC or by RRC for the scheduling the grant or assignment.

An indication by DCI may consist of at least one of the following. The indication by DCI may be an explicit indication, such as via a DCI field or by RNTI used to mask CRC of the PDCCH. The indication by DCI may be an implicit indication, for example, by a property. For instance, the indication by DCI may be by a DCI format, DCI size, Coreset or search space, Aggregation Level, and/or first resource element of the received DCI (e.g., index of first Control Channel Element). The mapping between the property and the value may be signaled by RRC or MAC.

RS may be interchangeably used with one or more of RS resource, RS resource set, RS port and/or RS port group.

RS may be interchangeably used with one or more of SSB, CSI-RS, SRS, DM-RS, TRS, PRS, and/or PTRS.

A reference signal may be interchangeably used with one or more of following: (i) Sounding reference signal (SRS); (ii) Channel state information-reference signal (CSI-RS); (iii) Demodulation reference signal (DM-RS); (iv) Phase tracking reference signal (PT-RS); and/or (v) Synchronization signal block (SSB).

A channel may be interchangeably used with one or more of following: (i) PDCCH; (ii) PDSCH; (iii) Physical uplink control channel (PUCCH); (iv) Physical uplink shared channel (PUSCH); and/or (v) Physical random access channel (PRACH).

A key performance indicator (KPI) may refer to, but not limited to, one or more of the following: (i) Signal quality (e.g., L1-RSRP, SINR, CQI, RSSI, RSRQ); (ii) Prediction performance (e.g., Percentage of the Top-1 genie-aided (e.g., best) beam is one of the Top-K predicted beams); (iii) Link quality (e.g., throughput, block error rate (BLER)); (iv) Data distribution (e.g., mean and/or variance of measured and/or predicted beam measurements); (v) RSRP (e.g., L1-RSRP) difference (e.g., the difference between measured and predicted RSRP of a beam).

A signal, channel, and/or message (e.g., as in DL or UL signal, channel, and message) may be used interchangeably.

A RS resource set may be interchangeably used with a RS resource and/or a beam group.

Beam reporting may be interchangeably used with CSI measurement, CSI reporting and/or beam measurement.

The proposed solutions for beam resources prediction may be used for beam resources belonging to a single or multiple cells as well as single or multiple TRPs.

CSI reporting may be interchangeably used with CSI measurement, beam reporting and/or beam measurement.

A RS resource set may be interchangeably used with a beam group.

A Set B may be interchangeably used with a set of RS resource sets, beams, beam-pairs, beam RS resources, RS resources and/or a beam pattern.

Set B may be interchangeably used with measurement RS resources, measurement RS resource set, measurement beam resources, measurement beam resource set, measurement beam pattern, measurement TCI states, and/or measurement TCI state group.

A Set A may be interchangeably used with a set of RS resource sets, beams, beam-pairs, beam RS resources, RS resources, and/or a beam pattern.

Beam prediction accuracy may be interchangeably used with prediction accuracy.

The WTRU may receive configuration information (e.g., from a network). For example, the WTRU may be configured with (e.g., the configuration information may indicate) one or more of the following (e.g., via RRC/MAC-CE/DCI). For example, the WTRU may be configured with one RS resource set where, for example, one or more RS resources associated to the RS resource set may be associated to one or more of Set B, Set A and/or neither (e.g., not with Set A nor Set B). The association of an RS resource with Set B and/or Set A may be configured via RRC (e.g., via one or more parameters inside RS-ResourceConfig and/or RS-ResourceSetConfig), MAC-CE, and/or DCI (e.g., a bitmap-based activation/indication of association of RS resources with Set B and/or Set A).

The WTRU may be configured with two or more RS resource Sets wherein each RS resource set is associated to either Set B or Set A.

The WTRU may be configured with one or more interference measurement resources (e.g., CSI-IM). For example, the WTRU may be configured with CSI-IM resources corresponding to one or more beams associated to Set B and/or Set A.

For example, the WTRU may be configured with one or more thresholds. For instance, the WTRU may be configured with one or more accuracy (e.g., prediction accuracy, measurement accuracy) thresholds. For example, the WTRU may be configured with a confidence level (e.g., confidence on a measurement) threshold. For example, the WTRU may be configured with a time threshold (e.g., ms, slots, frames, etc.). For example, the WTRU may be configured with a LOS probability threshold. For example, the WTRU may be configured with a WTRU speed threshold. For example, the WTRU may be configured with a channel stability threshold. For example, the WTRU may be configured with a prediction error threshold. For example, the WTRU may be configured with channel quality (e.g., noise power, RSRP, SINR, CQI etc.) thresholds.

The WTRU may be configured with a number of predicted beams/qualities (e.g., which may be denoted by K) to report in a CSI-Report.

The WTRU may be configured with one or more feedback resources (e.g., CSI-Report resources). In an example, the WTRU may be configured with two CSI-Report resources with different periodicity. For instance, the WTRU may be configured with a number, (e.g., denoted by K), of predicted beams/qualities to report in a CSI-Report. A feedback resource may be the granularity levels for RSRP reporting. For instance, a default/fixed granularity level and/or a fixed granularity level associated to Top-1 beam (e.g., highest quality beam) and one or more small granularity level associated to second best and lower quality beams.

The WTRU may perform measurements on RSs associated to Set B and/or Set A. Based on the measurements, the WTRU may determine measured beam qualities (e.g., RSRP, noise power) of measured RSs associated to Set B and/or Set A. Based on the measurements associated to beams/RSs associated to Set B, the WTRU may determine one or more of the following.: The WTRU may determine Predicted best (e.g., beams with highest RSRP) beams. The WTRU may predict beam indices of Top-K highest quality beams. The WTRU may determine predicted qualities (e.g., RSRPs). The WTRU may predict RSRPs of beams associated to Set A (e.g., also including Set B). A predicted beam quality/predicted RSRP may refer to a beam quality/RSRP associated to a beam, not obtained by directly measuring the RS associated to a beam (e.g., obtained by AIML model and/or through other filtering/signal processing techniques performed on RS measurements by the WTRU).

The WTRU may report (e.g., via CSI-Report) predicted qualities/RSRPs with one or more granularity levels. For example, the WTRU may report a Top-K predicted RSRPs with a fixed granularity level. For example, the WTRU may report a Top-1 predicted RSRP with a first granularity level, and a second best and lower predicted RSRP with a second granularity level (e.g., where first granularity level greater than a second granularity level). The granularity level associated with a Top-1 predicted RSRP may be fixed. The granularity level associated to the second best and lower quality predicted RSRPs may be determined and/or selected based on K. For example, the WTRU may select a second granularity level when configured with a small K (e.g., when K is less than a threshold). The WTRU may select a third granularity level when configured with a large K (e.g., where K is greater than a threshold). The WTRU may indicate the selected and/or granularity level to gNB (e.g. via flag-based indication indicating, default or smaller and/or larger granularity level used).

The WTRU may measure CSI-IM resources associated to one or more beams/RSs. Based on the measurements, the WTRU may determine interference power associated to one or more beams. Based on the RSRP (e.g., measured RSRP) and interference power associated to a beam (e.g., measured beam), the WTRU may determine SINR associated to a beam.

Set A may be interchangeably used with one or more of estimation beams, prediction beams, a resource configuration for prediction, a RS resource set for prediction and RS resources for prediction, a resource configuration for Set A, a RS resource set for Set A and/or RS resources for Set A.

Set B may be interchangeably used with one or more of transmission beams, measurement beams, a resource configuration for measurement, a RS resource set for measurement and RS resources for measurement, a resource configuration for Set B, a RS resource set for Set B, and/or RS resources for Set B.

The WTRU may report differently for Set A than Set B. For instance, the WTRU may use different criteria to determine whether the report comprises a measured beam quality or a predicted beam quality for the beams of Set A than the WTRU uses to determine whether the report comprises a measured beam quality or a predicted beam quality for the beams of Set B. For instance, the WTRU may use different Modes, such as those defined herein, for reporting the beams of Set A (e.g., the Top-K beams of Set A) than the mode used to report the beams of Set B (e.g., the Top-K beams of Set B). For example, the Modes may define one or more criteria that the WTRU uses to determine how to report for Set A and/or Set B. For example, the WTRU may be configured to determine whether the report comprises a measured beam quality or a predicted beam quality for the beams of a first subset of beams of Set A using first criteria, and the WTRU may be configured to determine whether the report comprises a measured beam quality or a predicted beam quality for the beams of a second subset of beams Set B using second criteria that is different than the first criteria. As such, the WTRU may determine what and/or how to report for the beams of Set A independent from the determination of what and/or how to report for the beams of Set B.

The WTRU may determine a mode of beam reporting for Set B. The mode may be one or more of the following. According to a first mode (e.g. Mode 1), the WTRU may report measured RSRPs of Top-K beams associated to Set B. According to a second mode (e.g. Mode 2), the WTRU may report predicted RSRPs of Top-K beams associated to Set B.

The WTRU may determine a mode of beam reporting based on one or more of the following. For example, he WTRU may determine a beam reporting mode for each Set B beam. For instance, the WTRU may determine a first beam reporting mode for a first Set B beam and a second beam reporting mode for a second Set B beam (e.g., based on measurements of each Set B beams).

For example, the WTRU may determine a beam reporting mode for all Set B beams. For example, the WTRU determine a beam reporting mode for all Set B beams (e.g., based on measurements of all Set B beams).

For example, the WTRU may determine the mode of beam reporting based on a gNB configuration/indication. For example, the WTRU may receive a configuration (e.g., via RRC) of the beam reporting mode e.g., from a gNB. The WTRU may receive an indication (e.g., via DCI and/or MAC CE) of the beam reporting mode. The indication may be an indication of a mode among configured candidate beam reporting modes (e.g., via RRC).

The WTRU may determine the mode of beam reporting based on WTRU determination. The WTRU may determine the beam reporting mode (e.g., based on WTRU measurements). For example, The WTRU may report predicted RSRPs for one or more reported (e.g., Top-K) Set B beam(s) based on one or more of the following conditions being satisfied by that beam. The WTRU may report predicted RSRPs for one or more reported (e.g., Top-K) Set B beam(s) based channel quality. For example, if measured channel quality great than or equal to a threshold, the WTRU may determine a first mode (e.g., mode 1). If the measured channel quality less than a threshold, the WTRU may determine a second mode (e.g., mode 2). The channel quality may be one or more of L1-RSRP, L3-RSRP, CQI, SNR, SINR, (hypothetical) PDCCH BLER, PDSCH BLER, and/or etc.

The WTRU may report predicted RSRPs for one or more reported (e.g., Top-K) Set B beam(s) based on noise power. For example, if measured noise power less than or equal to a threshold, the WTRU may determine a first mode (e.g., mode 1). If the measured noise power is greater than a threshold, the WTRU may determine a second mode (e.g., mode 2).

The WTRU may report predicted RSRPs for one or more reported (e.g., Top-K) Set B beam(s) based on WTRU speed. For example, if measured WTRU speed less than or equal to a threshold, the WTRU may determine a first mode (e.g., mode 1). If the measured WTRU speed greater than a threshold, the WTRU may determine a second mode (e.g., mode 2).

The WTRU may report predicted RSRPs for one or more reported (e.g., Top-K) Set B beam(s) based on LOS probability. For example, if measured LOS probability great than or equal to a threshold, the WTRU may determine a first mode (e.g., mode 1). If the measured LOS probability less than a threshold, the WTRU may determine a second mode (e.g., mode 2). For example, if measured LOS probability less than or equal to a threshold, the WTRU may determine a first mode (e.g., mode 1). If the measured LOS probability greater than a threshold, the WTRU may determine a second mode (e.g., mode 2).

The WTRU may report predicted RSRPs for one or more reported (e.g., Top-K) Set B beam(s) based on prediction accuracy. For example, if prediction accuracy less than or equal to a threshold, the WTRU may determine a first mode (e.g., mode 1). If the prediction accuracy greater than a threshold, the WTRU may determine a second mode (e.g., mode 2). The prediction accuracy may be beam prediction accuracy (e.g., predicted Top-K beams equals measured Top-K beams).

The WTRU may report predicted RSRPs for one or more reported (e.g., Top-K) Set B beam(s) based on Prediction error. For example, if prediction error greater than or equal to a threshold, the WTRU may determine a first mode (e.g., mode 1). If the prediction error less than a threshold, the WTRU may determine a second mode (e.g., mode 2). For example, if prediction error less than or equal to a threshold, the WTRU may determine a first mode (e.g., mode 1). If the prediction error greater than a threshold, the WTRU may determine a second mode (e.g., mode 2). The prediction error may be one or more of difference between predicted RSRP and measured RSRP.

The WTRU may report predicted RSRPs for one or more reported (e.g., Top-K) Set B beam(s) based on Channel stability. For example, channel stability greater than or equal to a threshold, the WTRU may determine a first mode (e.g., mode 1). If the channel stability less than a threshold, the WTRU may determine a second mode (e.g., mode 2). For example, channel stability less than or equal to threshold, the WTRU may determine a first mode (e.g., mode 1). If the channel stability greater than a threshold, the WTRU may determine a second mode (e.g., mode 2). The channel stability may be one or more of difference between L1-RSRP and L3-RSRP, difference between measured RSRP and a reference RSRP. The reference RSRP may be one or more of average measured RSRP (e.g., L1-RSRP or L3-RSRP), an indicated/configured reference RSRP (e.g., via one or more of RRC, MAC CE and/or DCI).

The WTRU may report predicted RSRPs for one or more reported (e.g., Top-K) Set B beam(s) based on Confidence interval. The WTRU may determine the beam reporting mode based on confidence interval associated with predicted and/or measured RSRP. For example, the WTRU may be configured with a one or more confidence interval(s) with a lower and upper RSRP thresholds. For example, the WTRU may apply a first RSRP reporting mode (e.g., mode 1) if the measured RSRP is within the preconfigured lower and upper RSRP thresholds. For example, the WTRU may apply a second RSRP reporting mode (e.g., mode 2) if the measured RSRP is outside of the preconfigured lower and upper RSRP thresholds. For example, the WTRU may apply a first RSRP reporting mode (e.g., mode 1) if the predicted RSRP is within the preconfigured lower and upper RSRP thresholds. For example, the WTRU may apply a second RSRP reporting mode (e.g., mode 2) if the predicted RSRP is within the preconfigured lower and upper RSRP thresholds. The confidence interval may be expressed and/or associated with a confidence level. For example, the confidence level may be expressed as a percentage. For example, the confidence level of X % may be interpreted as the WTRU is X % confident that the predicted and/or measured value lies within the confidence interval. For example, the value of X may be configured or predefined. For example, the value of X may be 90%, 95% or the likes. For instance, if both the measured and predicted RSRPs are within the preconfigured confidence intervals, the WTRU may select the reporting mode whose confidence level is higher. In some examples, if both the measured and predicted RSRPs are within the preconfigured confidence intervals, the WTRU may select the reporting mode whose confidence interval width is the smallest (e.g., the difference between lower and upper threshold is small). For example, the WTRU may be configured to determine the beam reporting mode at the granularity of each beam. For example, the WTRU may determine beam reporting mode individually for each beam within the reporting instance based on one or more conditions herein. In some examples, the WTRU may be configured to determine the beam reporting mode at the granularity of each reporting instance. For example, the WTRU may apply the determined beam reporting mode to all the beams within the reporting instance.

The WTRU may determine the beam reporting based on multiple parameters, which may be used for the determination of the beam reporting mode. For example, channel quality and/or noise power may be jointly used. For example, if noise power is greater than a first threshold and channel quality less than a second threshold, the WTRU may determine a second beam reporting mode (e.g., mode 2). Otherwise, the WTRU may determine a first beam reporting mode (e.g., mode 1).

The WTRU may determine the beam reporting based on one or more thresholds that may be configured/indicated via one or more of RRC, MAC CE and DCI (e.g., by a gNB).

The WTRU may determine the beam reporting based on measurement that may be based on one or more RSs. The one or more RSs may be quasi-co located (QCLed) (e.g., QCL Type-D) with one or more Set B beams. The one or more RSs may Set B beams or dedicated RSs for determination of a beam reporting mode. The one or more RSs may be one or more of DM-RS, CSI-RS, SSB, and/or PT-RS.

The WTRU may report using the first mode in a via a first feedback resource (e.g., CSI-Report resource configured with large periodicity). The WTRU may report using the second beam reporting mode via a second feedback resource (e.g. the second CSI-Report resource configured may be configured shorter periodicity than the first CSI-Report resource).

A WTRU may determine, be configured, and/or indicate to report one or more measured quality parameters for one or more beams from Set A beams. For example, the WTRU may receive one or more configuration information and/or indications via SIB, RRC, MAC-CE, DCI. For example, the measured quality parameters may be one or more of the RSRP, RSSI, SINR, etc. In some examples, the WTRU may determine, receive configuration information, be configured, and/or indicate with the number of beams from Set A beams, for which the WTRU may report one or more configured, indicated, and/or determined quality parameters. In some examples, the WTRU may determine, be configured, and/or indicate to report the configured and/or indicated number (e.g., K) of beams from Set A beams, with the highest quality (e.g., Top-K). For example, the WTRU may report one or more of the configured and/or indicated quality parameters for the configured and/or indicated number (e.g., K) of beams from Set A beams, for which the measured quality parameters have the highest value. The WTRU may report the configured and/or indicated number (e.g., K) of beams from Set A beams with the highest measured RSRP. The WTRU may report the configured and/or indicated number (e.g., K) of beams from Set A beams with the highest measured RSSI. The WTRU may report the configured and/or indicated number (e.g., K) of beams from Set A beams with the highest measured SINR.

The WTRU may determine, be configured, and/or indicate with one or more of reporting modes for reporting one or more beams from Set A beams with the highest measured quality parameters. For example, the WTRU may receive one or more configuration information and/or indications via SIB, RRC, MAC-CE, DCI, etc. For example, the WTRU may determine, be configured, and/or indicated with one or more reporting modes for the (e.g., Top-K) beams from set A beams. For example, the WTRU may determine, be configured, and/or indicate with reporting Mode 1, Mode 2, Mode 3, etc., for example for reporting Top-K beams from set A beams.

The WTRU may determine, be configured, and/or indicate to report one or more predicted quality parameters for one or more of the beams from Set A beams (e.g. mode 1). In an example, the WTRU may determine, be configured, and/or indicated to report one or more predicted quality parameters for a determined, configured, and/or indicate number of beams with highest predicted quality parameters (e.g., Top-K) from Set A beams. For example, the WTRU may report predicted RSRP of K beams associated to Set A with the highest predicted RSRP values, the WTRU may report predicted RSSI of K beams associated to Set A with the highest predicted RSSI values, the WTRU may report predicted RSSI of K beams associated to Set A with the highest predicted SINR values.

For example, the WTRU may determine, be configured, and/or indicate to report the absolute value of one or more of the predicted quality parameters for the beam from Set A beams with the highest predicted quality parameter value. The WTRU may determine, be configured, and/or indicate to report the differential value of the predicted quality parameters for the other determined, configured, and/or indicated (Top-K) beams for the Set A beams. The WTRU may calculate and/or determine the differential values for the predicted quality parameters for other beams based on the difference with the predicted and/or reported absolute value of the beam with the highest predicted quality parameter value. For example, the WTRU may report the absolute value of the predicted RSRP for the beam with the highest predicted RSRP value and differential predicted RSRP for the other (Top-K) beams. The WTRU may report the absolute value of the predicted RSSI for the beam with the highest predicted RSSI value and differential predicted RSSI for the other (Top-K) beams. The WTRU may report the absolute value of the predicted SINR for the beam with the highest predicted SINR value and differential predicted SINR for the other (Top-K) beams, etc.

In some examples, a WTRU that has predicted one or more quality parameters for one or more beams from Set A beams may order the beams based on the predicted values in descending order. The WTRU may order beams so that the first beam (e.g., Top-1 beam) may have the highest predicted value, the second beam may have the second highest predicted value, and etc. The WTRU may determine, be configured, and/or indicate to report (e.g. only) the differential value for the predicted quality parameters for the second beam, third beam, fourth beam, and so forth based on the order of the beams. For example, the WTRU may calculate and/or determine the differential values for the predicted quality parameters for second, third, etc. beams based on the difference with the first beam (e.g., with the highest predicted value). The WTRU may determine, be configured, and/or indicate to not report the predicted value for the first beam (e.g., with the highest predicted value) (e.g., Top-1 beam).

For example, the WTRU may send an indication (e.g., a flag indication) on whether the absolute value of the predicted quality parameters for the first beam (e.g., Top-1 beam) is reported. For example, a first value (e.g., value zero) may indicate that the absolute value of the predicted quality parameters for the first beam (e.g., Top-1 beam) is not reported. For instance, a second value (e.g., value one) may indicate that the absolute value of the predicted quality parameters for the first beam (e.g., Top-1 beam) is reported.

The WTRU may determine, be configured, and/or indicate to report one or more predicted quality parameters for one or more of the beams from Set A beams, where the WTRU may send the report for a configured, indicated, and/or determined number of the beams with highest or lowest predicted vales for the corresponding quality parameters (e.g. mode 2). For example, the WTRU may receive the configured and/or indicate number of beams to be reported via SIB, RRC, MAC-CE, and/or DCI.

For example, the WTRU may determine, be configured, and/or indicate with a first number of beams (e.g., K1) with highest predicted quality values (e.g., best beams). For example, the WTRU may report the configured, indicated, and/or determined number of beams with the highest predicted RSRP. The WTRU may report the configured, indicated, and/or determined number of beams with the highest predicted RSSI. The WTRU may report the configured, indicated, and/or determined number of beams with the highest predicted SINR.

For example, the WTRU may determine, be configured, and/or indicate with a second number of beams (e.g., K2) with lowest predicted quality values (e.g., worst beams). For example, the WTRU may report the configured, indicated, and/or determined number of beams with the lowest predicted RSRP. The WTRU may report the configured, indicated, and/or determined number of beams with the lowest predicted RSSI. The WTRU may report the configured, indicated, and/or determined number of beams with the lowest predicted SINR, etc.

In some examples, the configured, indicated, and/or determined first and second number of beams (e.g., K1 and K2) may be the same or different.

A WTRU may determine, be configured, and/or indicate to report one or more predicted and/or measured quality parameters for one or more of the beams from Set A beams. The WTRU may determine on whether to report the measured, predicted, or both measured and predicted quality parameters based on one or more conditions, threshold, events, etc. (e.g. mode 3). For example, the WTRU may receive configuration information, for example including one or more threshold values, for example via RRC, MAC-CE, DCI, etc.

A WTRU may determine to report one or more measured and/or predicted quality parameters for Top-K beams from Set A beams, based on the difference in the time that the quality parameter is measured and the reporting time. For example, the WTRU may report measured quality parameters (e.g., RSRP, RSSI, SINR, etc.) for one or more (e.g., Top-K) beams associated to Set A for which the difference between the beams' quality parameters time of measurement and reporting time is lower than a determined, configured and/or indicated first time threshold (e.g., time_threshold1). In some examples, the WTRU may report predicted quality parameters (e.g., RSRP, RSSI, SINR, etc.) for one or more (e.g., Top-K) beams associated to Set A for which the difference between the beams' quality parameters time of measurement and reporting time is higher than a determined, configured and/or indicated second time threshold (e.g., time_threshold2). In some examples, the WTRU may report measured or predicted quality parameters (e.g., RSRP, RSSI, SINR, etc.) for the (e.g., Top-K) beams from Set A beams for which the difference between the time of measurement and time of reporting is higher than the first time threshold (e.g., time_threshold1) and lower than the second time threshold (e.g., time_threshold2). The WTRU may determine to report the measured or predicted quality parameters for (e.g., Top-K) beams from Set A beams based on one or more of the following example conditions.

The WTRU may determine to report the measured or predicted quality parameters for (e.g., Top-K) beams from Set A beams based on Noise power. The WTRU may determine to report predicted quality parameters for the beams from Set A beams, for which noise power is higher than a corresponding threshold. In some examples, the WTRU may report measured quality parameters for the beams from Set A beams, for which noise power is lower than the corresponding threshold.

The WTRU may determine to report the measured or predicted quality parameters for (e.g., Top-K) beams from Set A beams based on SINR and/or CQI. The WTRU may determine to report predicted quality parameters for the beams from Set A beams, for which SINR, CQI, etc. is lower than a corresponding threshold. In some examples, the WTRU may report measured quality parameters for the beams from Set A beams, for which SINR, CQI, etc. is higher than the corresponding threshold.

The WTRU may determine to report the measured or predicted quality parameters for (e.g., Top-K) beams from Set A beams based on WTRU speed. The WTRU may determine to report predicted quality parameters for the beams from Set A beams, if WTRU's speed is lower than a corresponding threshold. In some examples, the WTRU may report measured quality parameters for the beams from Set A beams, if WTRU's speed is higher than the corresponding threshold.

The WTRU may determine to report the measured or predicted quality parameters for (e.g., Top-K) beams from Set A beams based on LOS probability. The WTRU may determine to report predicted quality parameters for the beams from Set A beams, for which the probability of LOS is lower than a corresponding threshold. In some examples, the WTRU may report measured quality parameters for the beams from Set A beams, for which the probability of LOS is higher than the corresponding threshold.

The WTRU may send an indication (e.g., to a gNB) indicating whether predicted or measured quality parameters are reported. For example, the indication may be for all the reported beams. For example, one bit indication may indicate whether the reported qualities for the reported beams are predicted qualities or measured qualities (e.g., 0 may indicate measured quality and 1 may indicate predicted quality). In some examples, the indication may apply only for reported beams from one or more beams from Set A beams. In some solutions, the indication may be indicated for each beam. For example, the WTRU may send a bitmap where each bit corresponds to one of the beams (e.g., beam resources). The beams may be from one or more of all the reported beams, Set B beams, Set A beams (e.g., potentially precluding Set B beams). For instance, a first value (e.g., value zero) in a first bit in the bitmap corresponding to a first beam from Set A beams indicates that the predicted quality parameter is reported for the first beam. In some examples, a second value (e.g., value one) in a second bit in the bitmap corresponding to a second beam from Set A beams indicates that the measured quality parameter is reported for the second beam. In some examples, the WTRU may send an indication (e.g., a flag indication) on whether the absolute value of the predicted quality parameters for the first beam (e.g., Top-1 beam) is reported. For example, a first value (e.g., value zero) may indicate that the absolute value of the predicted quality parameters for the first beam (e.g., Top-1 beam) is not reported. In some examples, a second value (e.g., value one) may indicate that the absolute value of the predicted quality parameters for the first beam (e.g., Top-1 beam) is reported.

In some examples, payload size for reporting measured RSRP and predicted RSRP may be different based on WTRU identification/determination on whether to indicate measure RSRP. For example, for measured beams, 7 bits for L1-RSRP and/or 4 bits for differential L1-RSRP may be used. For predicted beams, 6 bits for L1-RSRP and/or 3 bits for differential L1-RSRP may be used.

For example, a WTRU may be configured/indicated a RSRP table for L1-RSRP and differential RSRP. In some examples, the indication may apply for both measured/predicted beams. In some examples, the indication may be independent for measured RSRPs and predicted RSRPs.

A WTRU may determine payload for RSRP reporting. For example, one or more of the following methods may be used. The WTRU may determine payload for RSRP reporting using gNB configuration/indication. For example, the WTRU may receive a configuration and/or indication of payload size for RSRP reporting. The configuration/indication may be for each beam, all the beams or Set A beams (potentially excluding Set B beams). For example, the WTRU may receive a configuration/indication of RSRP table. Each RSRP table may require different payload size for L1-RSRP and different L1-RSRP (for measured beams and/or predicted beams). Based on the configuration/indication, the WTRU may determine the payload size for RSRP reporting.

The WTRU may determine payload for RSRP reporting using WTRU determination. For example, the WTRU may determine payload size for RSRP reporting. For example, the WTRU may determine payload size for RSRP reporting based on RSRP type of each beam or all the reported beams. For example, for measured beams, 7 bits for L1-RSRP and/or 4 bits for differential L1-RSRP may be used. For predicted beams, 6 bits for L1-RSRP and/or 3 bits for differential L1-RSRP may be used. The total payload size for beam reporting may be determined based on number of reported measured L1-RSRPs/different L1-RSRPs and number of reported predicted L1-RSRPs/differential L1-RSRPs.

A WTRU may report information for measured/predicted RSRPs based on one or more of the following. The WTRU may report information for measured/predicted RSRPs based on 1 part reporting. For example, the WTRU may indicate all the information including CRIs/SSBRIs, measured L1-RSRPs/differential L1-RSRPs and predicted L1-RSRPs/differential L1-RSRPs. The WTRU may determine a total payload size for the reporting by assuming maximum size. For example, if payload size for measured RSRP greater than predicted RSRP, the WTRU may identify payload size of RSRP reporting as number of bits for reporting measured RSRP times the number of beams to be reported. If actual information size is less than the payload size, the WTRU may use padding of bits. For example, fixed bits (e.g., zeros) may be padded in the front of one or more of the whole information, the RSRP information for the firstly reported beam and the RSRP information for each beam. For example, when 7 bits for measured L1-RSRP and 6 bits for predicted L1-RSRP are supported, then the WTRU may include 0 in the front of 6 bits for predicted L1-RSRP if predicted RSRP is indicated.

The WTRU may report information for measured/predicted RSRPs based on two-part reporting. For example, the WTRU may indicate first information group in a first part and second information group in a second part. The first part information may determine a payload size for the second information group. For example, the first part may indicate whether to indicate measured RSRP/predicted RSRP for one or more of all the beams, Set A beams (potentially precluding Set B beams) and each beam. Based on the indication, the size of the second group may be determined. For example, if one measured L1-RSRP and one predicted L1-RSRP are reported, then 13 bits may be used. If two measured L1-RSRPs are reported, then 14 bits may be used. If two predicted L1-RSRPs are reported, then 12 bits may be used. The first part may indicate one or more CRIs/SSBRIs.

WTRU may report information for measured/predicted RSRPs based on three-part reporting. The WTRU may indicate first information group in a first part, second information group in a second part and third information group in a third part. For example, the first part may be number of CRIs/SSBRIs, the second part may be CRIs/SSBRIs and measured/predicted beam indication and the third part may be RSRPs. For example, the first part may be CRIs/SSBRIs, the second part may be measured/predicted beam indication and the third part may be RSRPs. The WTRU may determine a payload size of a next part based on the information of one or more previous parts.

To support AI/ML based beam predictions, a WTRU may be configured with Set A (Set A beams) and Set B (Set B beams). Alternatively or additionally, the WTRU may receive configuration for determining Set A and Set B. AI/ML model may use measurements (e.g., beam quality (e.g., RSRP) measurements) of Set B beams to predict the beam quality (e.g., RSRP of each beam, top-K beams, etc.) of Set A beams. Selecting a Set A with a sufficient quality (e.g., a set of beams that has the potential to provide one or more sufficient quality (e.g., RSRP is greater than a threshold) may be important for the proper operation of beam selection based on AI/ML based beam predictions. To support gNB for selecting a Set A with sufficient quality, the WTRU may determine/estimate the quality of Set A and report the determined/estimated quality of Set A to gNB. To this end, the WTRU may use one or more of the following procedures.

A WTRU may determine and/or estimate quality of Set A based on predicted beam quality of one or more beams and one or more thresholds (e.g., beam quality (e.g., RSRP) threshold, threshold on number of beams, etc.). The thresholds may be preconfigured via RRC signaling, MAC-CE indication, and/or a DCI indication. The WTRU may determine that the quality of Set A is sufficient if the beam quality (e.g., RSRP) of the Top-1 predicted beam greater than or equal to a preconfigured beam quality threshold. If the beam quality (e.g., RSRP) of the Top-1 predicted beam is less than a preconfigured beam quality threshold, the WTRU may determine that the quality of Set A is insufficient. In an example, the WTRU may determine that the quality of Set A is sufficient if the beam quality (e.g., RSRP) of all the Top-K (e.g., K is preconfigured via RRC signaling, MAC-CE indication, DCI indication) predicted beams is greater than or equal to a preconfigured beam quality threshold. If the beam quality (e.g., RSRP) of all Top-K predicted beams is less than a preconfigured beam quality threshold, the WTRU may determine that the quality of Set A is insufficient. In some examples, the WTRU may determine that the quality of Set A is sufficient if the number of beams with predicted beam quality exceeding a preconfigured beam quality threshold is greater than or equal to a preconfigured threshold number of beams. A WTRU may determine that the quality of Set A is insufficient if the number of beams with a predicted beam quality exceeding a preconfigured beam quality threshold is less than a preconfigured threshold number of beams. In some examples, the WTRU may determine that the quality of Set A is sufficient if the number of beams with predicted beam quality below a preconfigured beam quality threshold is less than or equal to a preconfigured threshold number of beams. A WTRU may determine that quality of Set A is insufficient if the number of beams with predicted beam quality below a preconfigured beam quality threshold is greater than a preconfigured threshold number of beams. For example, the WTRU may determine that the quality of Set A is sufficient if the average predicted beam quality of two or more (Top-K predicted beams, all beams in Set A) beams are greater than or equal to a preconfigured beam quality threshold. A WTRU may determine that the quality of Set A is insufficient if the average predicted beam quality of two or more (e.g., Top-K predicted beams, all beams in Set A) beams is less than a preconfigured beam quality threshold.

The WTRU may report the determined quality of Set A to the gNB based on one or more of the following procedures. The WTRU may determine or be configured/indicated to send/report quality of Set A based on if determined quality of Set A is insufficient.

The WTRU may determine or be configured/indicated to send/report quality of Set A along with (e.g., each) beam quality reports (e.g., in each beam reporting (e.g., transmitting RSRP reports) based on beam predictions).

The WTRU may determine or be configured/indicated to send/report quality of Set A at a preconfigured (e.g., preconfigured via one or more of RRC signaling, MAC-CE indication and/or DCI indication) periodicity.

The WTRU may determine or be configured/indicated to send/report quality of Set A based on receiving an indication (e.g., via one or more of MAC-CE indication and DCI indication) to report quality of Set A (e.g., along with next beam reporting (e.g., RSRP report transmission)).

The WTRU may report determined quality of Set A based on one or more of the following solutions. The WTRU may send 1 bit indication (bit value ‘1’ if Set A quality is sufficient and bit value ‘0’ if Set A quality is insufficient) to the gNB. For example, WTRU may report 1 bit indication of Set A quality as a part of beam report. In some examples, the WTRU may send 1 bit indication using dedicated resources (e.g., PUCCH, PUSCH).

The WTRU may indicate that quality of Set A is insufficient by transmitting a preconfigured sequence on a preconfigured resource (E.g., transmitting a preconfigured preamble on a PRACH resource).

The WTRU may adapt procedure related to reporting predicted beam quality (e.g., RSRP) based on the determined and/or reported quality of Set A. For example, if WTRU determine and/or report Set A quality is sufficient, WTRU may send/report beam IDs (e.g., CRIs) of a selected set (e.g., Top-K beams based on predicted RSRP) of beams in the RSRP report (1^{st} beam reporting procedure). For example, WTRU may not include predicted beam quality (e.g., predicted RSRP) of selected set of beams to the gNB in its RSRP report. If WTRU determines and/or reports Set A quality is insufficient, the WTRU may send/report IDs (e.g., CRIs) of a selected set (e.g., Top-K beams based on predicted RSRP) of beams and beam quality (e.g., RSRP) of corresponding beams in the RSRP report (2^{nd} beam reporting procedure).

The WTRU may select preconfigure (e.g., preconfigured via RRC signaling, MAC-CE indication, DCI) first or second UL resource (e.g., PUCCH, PUSCH) for transmitting/sending RSRP report based on the selected procedure related to reporting beam quality. For example, in the case 1^{st} beam reporting procedure is selected, the WTRU may select first UL resources. In the case 2^{nd} beam reporting procedure is selected, WTRU may select second UL resource.

1. A wireless transceiver/receiver unit (WTRU) comprising:
a processor configured to:
receive configuration information, wherein the configuration information comprises: an indication of a first set of beams and an indication of a second set of beams, wherein the second set of beams is a subset of the first set of beams, an indication of a second set of RS resources associated with the second set of beams;
determine a measured beam quality associated with at last one beam of the beams of the second set of beams based on measurements performed on the second set of RS resources;
determine a predicted beam quality associated with at last one beam of the beams of the first set of beams based on the measured beam quality for the one or more beams of the second set of beams; and
send a report, wherein the report comprises an indication of a first subset of beams of the first set of beams and an indication of a second subset of beams of the second set of beams, wherein the first subset of beams is not part of the second set of beams;
wherein different criteria used to determine whether the report comprises a measured beam quality or a predicted beam quality for each beam of the first subset of beams than is used to determine whether the report comprises a measured beam quality or a predicted beam quality for each beam of the second subset of beams.

2. The WTRU of claim 1, wherein the measured beam quality comprises Reference Signal Received Power (RSRP), Signal-to-Interference-plus-Noise Ratio (SINR), or noise power, and wherein the predicted beam quality comprises Reference Signal Received Power (RSRP), Signal-to-Interference-plus-Noise Ratio (SINR), or noise power.

3. The WTRU of claim 1, wherein the processor is configured to determine the second subset of beams from the second set of beams based on a measured Reference Signal Received Power (RSRP) associated with each beam of the second set of beams.

4. The WTRU of claim 1, wherein the processor is configured to determine the second subset of beams from the second set of beams based on a predicted Reference Signal Received Power (RSRP) associated with each beam of the second set of beams.

5. The WTRU of claim 1, wherein the report comprises a measured beam quality for each beam of the second subset of beams or a predicted beam quality for each beam of the second subset of beams.

6. The WTRU of claim 1, wherein the report comprises a measured beam quality for at least one beam of the second subset of beams and a predicted beam quality for at least one beam of the second subset of beams.

7. The WTRU of claim 1, wherein, for each beam of the second subset, the report comprises a predicted beam quality for the beam when one or more conditions associated with the beam are satisfied, and otherwise, the report comprises a measured beam quality for the beam.

8. The WTRU of claim 7, wherein the one or more conditions comprises any combination of:
a Signal-to-Interference-plus-Noise Ratio (SINR) associated with the beam being less than a SINR threshold;
a Channel Quality Indicator (CQI) associated with the beam being less than a CQI threshold;
a noise power associated with the beam being greater than a noise power threshold and an SINR associated with the beam being greater than a SINR threshold;
a speed of the WTRU speed being less than a speed threshold; or
a Line of Sight (LOS) probability associated with the beam being less than a LOS threshold.

9. The WTRU of claim 1, wherein the report comprises a predicted beam quality for each beam of the first subset of beams.

10. The WTRU of claim 1, wherein the first subset of beams comprises a first number of beams of the first set of beams associated with a first number of the highest measured beam qualities and a second number of beams of the first set of beams associated with a second number of the lowest measured beam qualities.

11. A method performed by a wireless transceiver/receiver unit (WTRU), the method comprising:
receiving configuration information, wherein the configuration information comprises: an indication of a first set of beams and an indication of a second set of beams, wherein the second set of beams is a subset of the first set of beams, an indication of a second set of RS resources associated with the second set of beams;
determining a measured beam quality associated with at least one of the beams of the second set of beams based on measurements performed on the second set of RS resources;
determining a predicted beam quality associated with each at least one the beams of the first set of beams based on the measured beam quality for the one or more beams of the second set of beams; and
sending a report, wherein the report comprises an indication of a first subset of beams of the first set of beams and an indication of a second subset of beams of the second set of beams, wherein the first subset of beams is not part of the second set of beams;
wherein different criteria used to determine whether the report comprises a measured beam quality or a predicted beam quality for each beam of the first subset of beams than is used to determine whether the report comprises a measured beam quality or a predicted beam quality for each beam of the second subset of beams.

12. The method of claim 1, wherein the measured beam quality comprises Reference Signal Received Power (RSRP), Signal-to-Interference-plus-Noise Ratio (SINR), or noise power, and wherein the predicted beam quality comprises Reference Signal Received Power (RSRP), Signal-to-Interference-plus-Noise Ratio (SINR), or noise power.

13. The method of claim 1, wherein the second subset of beams is determined from the second set of beams based on a measured Reference Signal Received Power (RSRP) associated with each beam of the second set of beams.

14. The method of claim 1, wherein the second subset of beams is determined from the second set of beams based on a predicted Reference Signal Received Power (RSRP) associated with each beam of the second set of beams.

15. The method of claim 1, wherein the report comprises a measured beam quality for each beam of the second subset of beams or a predicted beam quality for each beam of the second subset of beams.

16. The method of claim 1, wherein the report comprises a measured beam quality for at least one beam of the second subset of beams and a predicted beam quality for at least one beam of the second subset of beams.

17. The method of claim 1, wherein, for each beam of the second subset, the report comprises a predicted beam quality for the beam when one or more conditions associated with the beam are satisfied, and otherwise, the report comprises a measured beam quality for the beam.

18. The method of claim 7, wherein the one or more conditions comprises any combination of:
a Signal-to-Interference-plus-Noise Ratio (SINR) associated with the beam being less than a SINR threshold;
a Channel Quality Indicator (CQI) associated with the beam being less than a CQI threshold;
a noise power associated with the beam being greater than a noise power threshold and an SINR associated with the beam being greater than a SINR threshold;
a speed of the WTRU speed being less than a speed threshold; or
a Line of Sight (LOS) probability associated with the beam being less than a LOS threshold.

19. The method of claim 1, wherein the report comprises a predicted beam quality for each beam of the first subset of beams.

20. The method of claim 1, wherein the first subset of beams comprises a first number of beams of the first set of beams associated with a first number of the highest measured beam qualities and a second number of beams of the first set of beams associated with a second number of the lowest measured beam qualities.
